(19) United States
(12) Patent Application Publication
(10) Pub. No.: US 2013/0068168 A1
(43) Pub. Date: Mar. 21, 2013

(54) LIVESTOCK FEEDER

(71) Applicant: Joe L. Payne, Kaw City, OK (US)

(72) Inventor: Joe L. Payne, Kaw City, OK (US)

(21) Appl. No.: 13/235,884

(22) Filed: Sep. 19, 2011

(51) Int. Cl. A01K 5/00; A01K 1/10

(52) U.S. Cl. 119/60

(57) ABSTRACT

A livestock feeder having a plurality of polymeric panels interconnectable with one another to define a hay retaining space. Each polymeric panel has a first vertical end member, a second vertical end member, and a plurality of horizontal retainer members extending between the first vertical end member and the second vertical end member. The first vertical end member has at least one angularly disposed mortise, and the second vertical end member has at least one angularly disposed tenon. The tenons of the second vertical end member are slidably receivable in the mortises of the first vertical end member of an adjacent like polymeric panel so as to support the adjacent like polymeric panels in an angular relationship to one another.

### BACKGROUND

Feed materials such as hay can be a major expense for herd managers or other persons involved in the livestock industry. Because livestock typically do not eat hay that has been trampled or soiled, hay feeders have become a popular means to feed livestock. Hay feeders provide the advantage of protecting hay from being contaminated or trampled, while allowing livestock to feed at will through provided openings. Over time, many different types of hay feeders have been developed in attempts to further minimize hay waste. See for example U.S. Pat. No. 5,533,345, the entire disclosure of which is hereby incorporated herein by reference.

Prior art feeders are typically bulky devices that are difficult to ship and transport, and are often made of metal, which may readily corrode when exposed to the elements. Further, the added weight of the metal, combined with the bulk of prior art feeders makes shipping, transporting, and assembling such prior art feeders a cumbersome and expensive process.

To that end, a need exists for a feeder that is lightweight, durable, resistant to the elements, and easy to assemble/disassemble, ship, and store. It is to such a feeder that the apparatus disclosed herein is directed.

### BRIEF DESCRIPTION OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a perspective view of an embodiment of a livestock feeder constructed in accordance with the inventive concepts disclosed herein.

FIG. 2 is a right front perspective front view of an embodiment of a panel of a livestock feeder according to the instant inventive concepts.

FIG. 3 is a left front perspective view of the panel of FIG. 2.

FIG. 4 is a sectional view taken along line 4-4 of FIG. 2.

FIG. 5A is a side elevational view of an embodiment of a panel showing a tenon according to the instant inventive concepts.

FIG. 5B is a side elevational view of an embodiment of a panel having a mortise according to the instant inventive concept.

FIG. 6 is an exploded perspective view of two connected panels.

FIG. 7 is a perspective view of a face-to-face angular connection between the two panels of FIG. 6.

### DETAILED DESCRIPTION OF EXEMPLARY EMBODIMENTS

Before explaining at least one embodiment of the presently disclosed and claimed inventive concepts in detail, it is to be understood that the inventive concepts are not limited in their application to the details of construction, experiments, exemplary data, and/or the arrangement of the components set forth in the following description, or illustrated in the drawings. The presently disclosed and claimed inventive concepts are capable of other embodiments or of being practiced or carried out in various ways. Also, it is to be understood that the phraseology and terminology employed herein is for purpose of description only and should not be regarded as limiting in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

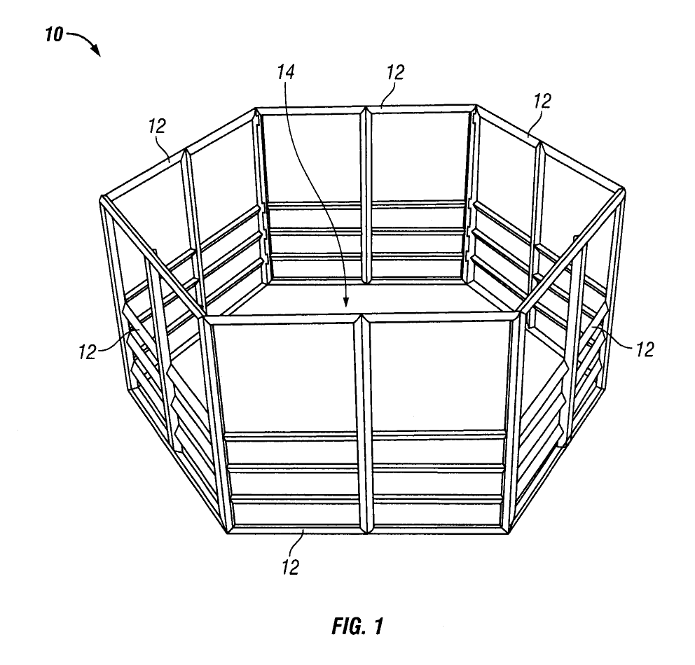

Referring now to the drawings and to FIG. 1 in particular, shown therein is a perspective view of an exemplary embodiment of a livestock feeder 10 constructed according to the instant inventive concepts. The livestock feeder 10 comprises a plurality of panels 12. The panels 12 are connectable with one another so as to define a hay retaining space 14. It is to be understood that while six panels 12 are shown in FIG. 1 as forming a hexagonal hay retaining space 14, the instant inventive concepts may be used with a different number of panels 12 (e.g., 2, 3, 4, 5, 7, 8, . . . , n, a plurality), which panels 12 may form hay retaining spaces 14 having a variety of shapes and sizes (e.g., triangular, square, rectangular, pentagonal, heptagonal, octagonal, polygonal, circular, oval, elliptical, and combinations thereof).

The hay retaining space 14 is preferably sized such that a conventional round bale of hay may be deposited therein, but it is to be understood that the hay retaining space 14 may have a variety of shapes and sizes and may allow other types of hay bales and/or other types of livestock feed to be deposited therein. For example, rectangular straw bales, hay piles, grain piles, grain pails, water containers, and other similar livestock items may be deposited in the hay retaining space 14 to prevent such items from being trampled on, defecated in, soiled, tipped over, and laid in by livestock, as will be understood by persons of ordinary skill in the art presented with the instant disclosure.

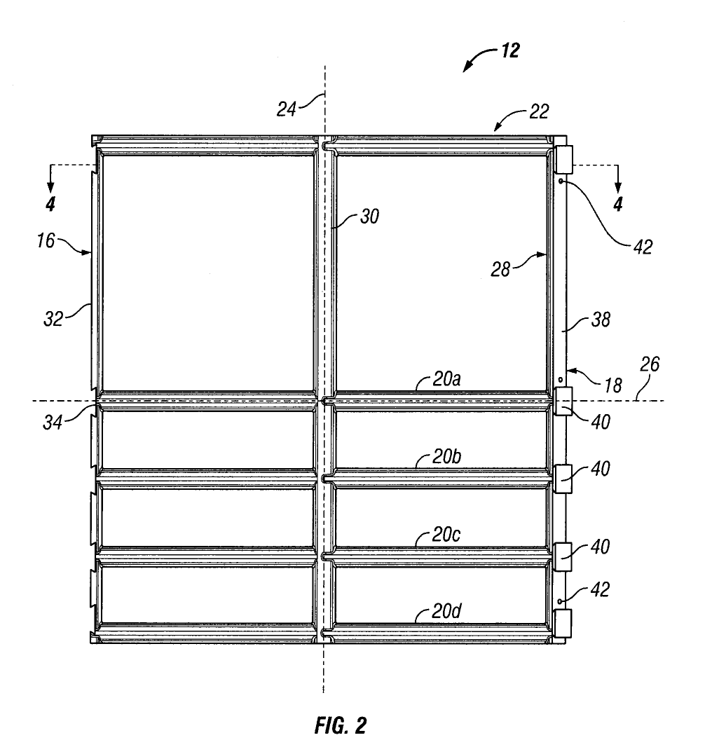

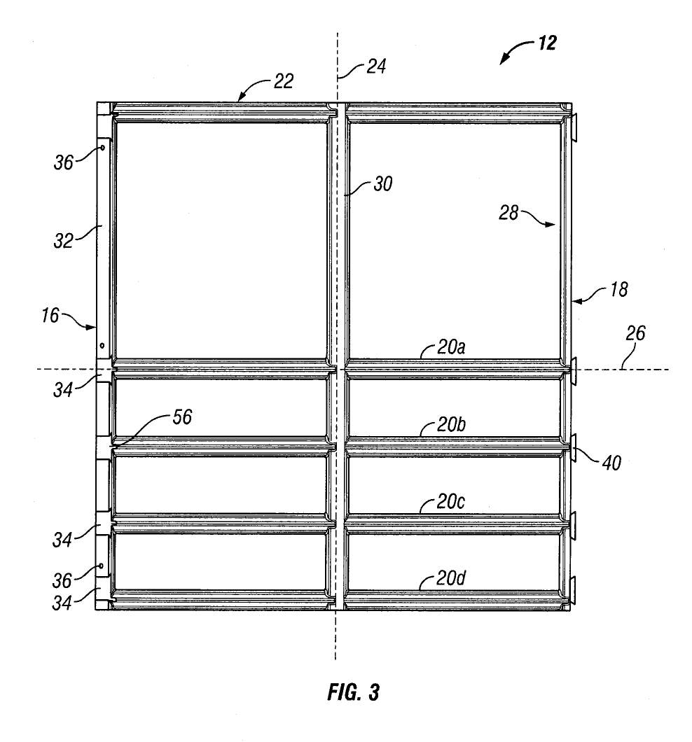

Referring now to FIGS. 2 and 3, one of the panels 12 is illustrated. The panel 12 comprises a first vertical end member 16, a second vertical end member 18, a plurality of horizontal retainer members 20a-20d, and a top member 22. The panel 12 further comprises a vertical axis 24 and a longitudinal axis 26.

In an exemplary embodiment, the panel 12 is unitary and is constructed of a polymeric material, and may be made by a conventional molding process, for example. Examples of suitable polymeric materials include, but are not limited to, polyethylene, polyvinylchloride, polystyrene, high-density polyvinylchloride, polypropylene, polycarbonates, ultra-high molecular weight polyethylene, and combinations thereof. The panel 12 is desirably fabricated of a polymeric material having angular deflection characteristics and memory so that the panel 12 can be angularly deflected by pressures exerted thereon and restored to a substantially non-deflected positions when such pressures are removed.

It is to be understood, however, that the panel 12 may be constructed of variety of materials, such as wood, fiberglass, metals, plastics, fabrics, polymers, resins, concrete, composite materials, and combinations thereof, and may comprise one or more bonded or otherwise connected layers of material, for example. It is to be further understood that a panel 12 according to the instant inventive concepts may have one or more coatings deposited on one or more surfaces thereof, such as antimicrobial coatings, salts, paints, anti-corrosion coatings, visibility-enhancing coatings, insecticidal coatings, and combinations thereof, for example. It is to be understood that the various components of the panel 12 may be made of different materials, for example, the first vertical end member 16 and the second vertical end member 18′ may be made of a first material, and the top member 22 and the plurality of horizontal retainer members 20a-20d may be made of a second material, which may be the same as, similar to, or different from, the first material.

The first vertical end member 16 and the second vertical end member 18 are connected to the horizontal retainer members 20a-20d and to the top member 22 in a planar, spaced apart relationship such that the first vertical end member 16 and the second vertical end member 18 are spaced apart along the longitudinal axis 26. The top member 22 is supported in a spaced apart relationship from the horizontal retainer member 20a such that an access opening 28 is defined by the first vertical end member 16, the top member 22, the second vertical end member 18, and the horizontal retainer member 20a. It is to be understood that in some exemplary embodiments of the instant inventive concept, the top member 22 may be omitted, and the access opening 28 may be defined by the first vertical end member 16, the second vertical end member 18, and the horizontal retainer member 20a.

The first vertical end member 16, the second vertical end member 18, the top member 22, and the horizontal retainer members 20a-20d may be formed as a unitary body, or may be connected via welds, adhesives, joints, bolts, rivets, solder, brackets, connectors, ultrasonic welds, or other suitable means, and combinations thereof, for example. Further, the first vertical end member 16, the second vertical end member 18, the top member 22, and the horizontal retainer members 20a-20d may have a variety of shapes, cross-sections, and sizes, such as round, square, oval, triangular, rectangular, V-shaped, X-shaped, “+”-shaped, polygonal, and combinations thereof, for example. In an exemplary embodiment, the first vertical end member 16, the second vertical end member 18, the top member 22, and the horizontal retainer members 20a-n may be tubular, or hollow, but it is to be understood that they may also be solid, or combinations of one or more solid portion(s) and one or more hollow portion(s), for example.

The livestock access opening 28 may vary in shape and size depending on the particular livestock that the livestock feeder 10 is used with, for example. The access opening 28 functions to permit livestock to insert their head and/or necks through a panel 12, in order to access the hay, or other feed, deposited in the hay retaining space 14 (FIG. 1), but is configured such that livestock is prevented from entering the hay retaining space 14 and trampling or soiling the hay (or other feed) deposited therein, for example. As will be understood by persons of ordinary skill in the art presented with the instant disclosure, the access opening 28 may be varied depending on livestock head, neck, and horn size, livestock height, and combinations thereof, for example.

Also shown in FIGS. 2 and 3 is an optional medial vertical member 30. The medial vertical member 30 is shown spaced apart from the first vertical end member 16 and from the second vertical end member 18 along the longitudinal axis 26. While the medial vertical member 30 is shown as being spaced an equal distance from the first vertical end member 16 and from the second end member 18, it is to be understood that the medial vertical member 30 may be spaced form the first vertical end member 16 and the second vertical end member 18 at a variety of distances, including being spaced at a first distance from the first vertical end member 16 and a second distance from the second vertical end member 18 along the longitudinal axis 26, for example. The medial vertical member 30 may divide the access opening 28 to two portions, such as a first portion 28a and a second portion 28b, for example. It is to be understood that some exemplary embodiments may omit medial vertical member 30, depending, for example, based on factors such as the overall size of the panel 12, the type of livestock a livestock feeder 10 is to be used with, the material of which the panel 12 is constructed, and combinations thereof.

It should be understood that while the panel 12 has been shown to have four horizontal retaining members 20a-20d, any number of horizontal retainer members may be used with the instant inventive concept. Further, in embodiments comprising a medial vertical member 30, the horizontal retainer members may be connected to the first vertical end member 16 and the medial vertical member 30, and to the second vertical end member 18 and the medial vertical member 30, for example. Likewise, the top member 22 may be connected to the first vertical end member 16 and the medial vertical member 30, and to the second vertical end member 18 and the medial vertical member 30, for example. Optionally, the medial vertical member 30 may simply extend through or be adjoined or connected to one or more of the horizontal retainer members 20a-n and/or the top member 22.

It is to be further understood that while the first vertical end member 16 and the second vertical end member 18 are shown as being perpendicular to the top member 22 and the plurality of horizontal retainer members 20a-20d, the first vertical end member 16 and the second vertical end member 18, may connect to the top member 22 and the horizontal retainer members 20a-20d at various angles, ranging from 0°-360° relative to the vertical axis 24 and/or to the longitudinal axis 26, for example.

The first vertical end member 16 comprises a vertical face 32 (relative to the vertical axis 24) having one or more vertically spaced mortises 34 and one or more vertically spaced apertures 36 formed therein. The second vertical end member 18 comprises a vertical face 38 (relative to the vertical axis 24) having one or more vertically spaced tenons 40 extending therefrom and one or more vertically spaced apertures 42 formed therein.

In some exemplary embodiments, the first vertical end member 16 comprises a plurality of vertically spaced mortises 34 and a plurality of vertically spaced apertures formed therein, and the second vertical end member 18 comprises a plurality of corresponding vertically spaced tenons 40 extending therefrom, and a plurality of vertically spaced apertures 42 formed therein.

It will be appreciated that the apertures 36 and the apertures 42 are configured such that one or more apertures 36 are axially aligned with one or more apertures 42 when two or more panels 12 are connected to one another as will be described herein below. It is to be understood that in some embodiments apertures 36 and 42 may be formed into one or more of the mortises 34 and the tenons 40, although for the purpose of this disclosure, they have been shown and described as positioned between the mortises 34 and tenons 40 on vertical faces 32 and 38 respectively. The apertures 36 and 42 may be formed using any conventional technique, such as drilling, for example.

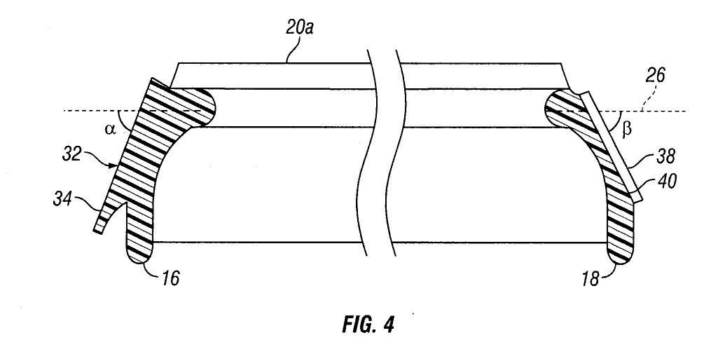

Referring now to FIG. 4, the vertical face 32 of the first vertical end member 16 is angularly disposed relative to the longitudinal axis 26, such that the plurality of mortises 34 and the plurality of apertures 36 are angularly disposed relative to the longitudinal axis 26 at a first angle α. Similarly, the face 38 of the second vertical end member 18 is angularly disposed relative to the longitudinal axis 26, such that the plurality of tenons 40 and the plurality of apertures 42 are angularly disposed relative to the longitudinal axis 26 at a second angle β. In an exemplary embodiment, the first angle α may be equal to the second angle β, but it is to be understood that angles α and β may correspond to one another and/or may be different in some exemplary embodiments of the inventive concept disclosed herein.

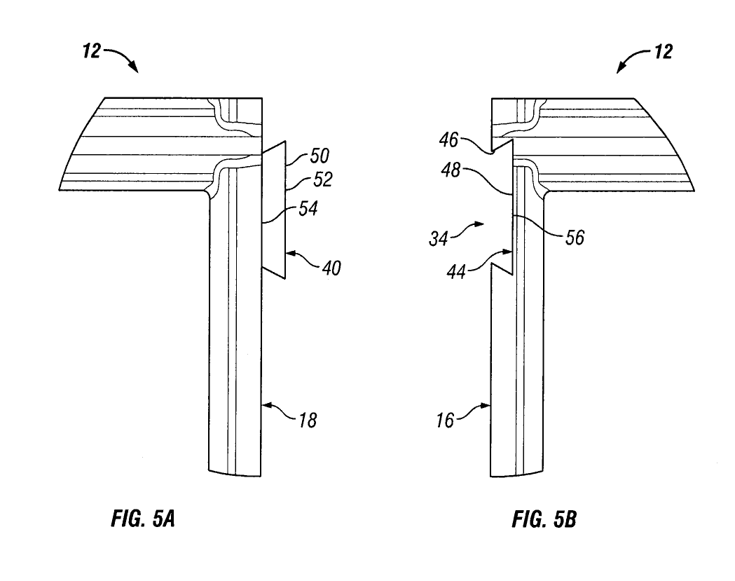

Referring now to FIGS. 5A and 5B, the mortises 34 comprise a groove 44 having a proximal end 46 and a distal end 48. The groove 44 is shown as tapering such that the groove 44 is wider at the distal end 48 than at the proximal end 46. It is to be understood that in some embodiments the groove 44 may taper such that the proximal end 46 is narrower than the distal end 48. Further, in some embodiments the groove 44 may not taper (e.g., the proximal end 46 and the distal end 48 have the same width), or may have more than one tapered portion such that a first portion of the proximal end 46 is narrower than a first portion of the distal end 48 and a second portion of the proximal end 46 is wider than a second portion of the distal end 48, for example. In some embodiments, the groove 44 may partially or completely overlap a location where one of the horizontal retainer members 20a-20d or the top member 22 connects to the second vertical end member 18, for example.

The tenons 40 comprise a projection 50 wherein the projection 50 has a proximal end 52 and a distal end 54. The projection 50 is shown as tapering such that the projections 50 is narrower at the proximal end 52 than at the distal end 54 (or the distal end 54 is wider than the proximal end 52). It is to be understood that in some embodiments the projection 50 may taper such that the proximal end 52 is wider than the distal end 54. Further, in some embodiments the projection 50 may not taper (e.g., the proximal end 52 and the distal end 54 have the same width), or may have more than one tapered portion such that a first portion of the proximal end 52 is narrower than a first portion of the distal end 54 and a second portion of the proximal end 52 is wider than a second portion of the distal end 54, for example.

In some embodiments, the projection 50 may partially or completely overlap (or be completely or substantially aligned with) a location where one of the horizontal retainer members 20a-20d or the top member 22 connects to the second vertical end member 18, for example.

The groove 44 is illustrated as having two open ends 56, but it is to be understood that a groove 44 according to the instant inventive concept may have two closed ends (not shown), one open end 56 and one closed end (not shown), or more than two open ends 56 and/or closed ends (not shown), for example.

The open ends 56 of the groove 44 allow the sliding insertion of a projection 50 of a tenon 40 into the groove 44 such that the projection 50 is releasably retained therein. In an exemplary embodiment, the groove 44 and the projection 50 have opposing tapers relative to their proximal ends 46 and 52, and distal ends 48 and 54, respectively. In other words, the proximal end 46 of the groove 44 is wider than the distal end of the groove 44, and the proximal end 52 of the projection 50 is narrower than the distal end 54, such that the projection 50 fits inside the groove 44, for example. Such arrangement results in the tenon 40 of the second vertical end member 18 being slidably receivable in the mortise 34 of the first vertical end member 16.

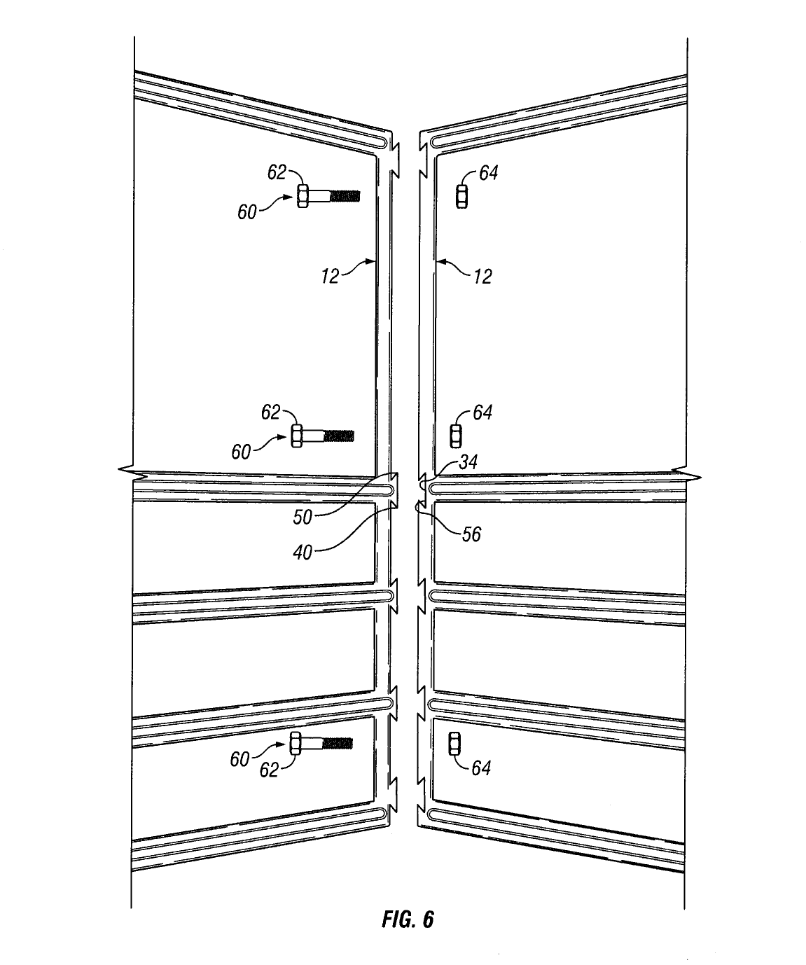

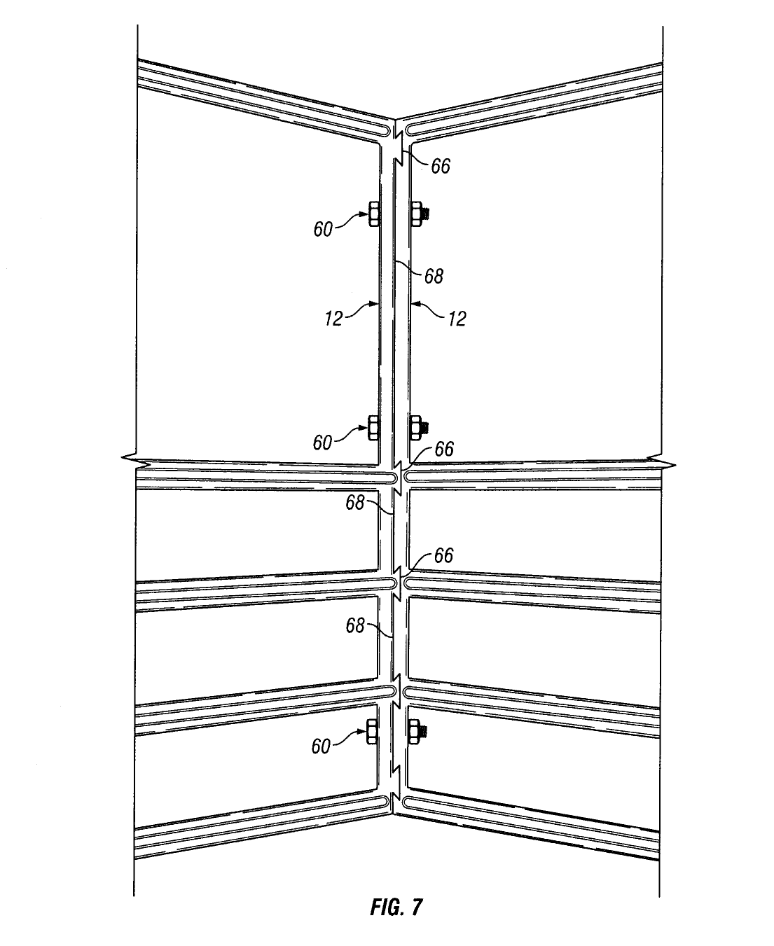

Referring now to FIGS. 6 and 7, to assemble a livestock feeder 10 according to the instant inventive concept, two adjacent panels 12 are connected to one another. As illustrated in FIG. 6, the first vertical end member 16 of one panel 12 is aligned with the second vertical end member 18 of a like panel 12 such that the tenons 40 are aligned with the mortises 34 relative to the vertical axis 24. Further, the apertures 36 and 42 are axially aligned, and the vertical faces 32 and 38 are likewise axially aligned with one another. The open ends 56 of the mortises 34 are likewise aligned with the projections 50 of the tenons 40.

Next, as shown in FIG. 7, the projections 50 of the tenons 40 are slid into the grooves 44 of the mortises 34 via one of the open ends 56 such that the projections 50 are releasably retained in the grooves 44. In an exemplary embodiment, the grooves 44 and the projections 50 have opposing tapers relative to their proximal ends 46 and 52, and distal ends 48 and 54, respectively. In other words, the proximal ends 46 of the grooves 44 are wider than the distal ends 48 of the grooves 44, and the proximal ends 52 of the projections 50 are narrower than the distal ends 54, such that the projections 50 fit snugly inside the grooves 44, for example. The insertion of the tenon 40 of a first panel 12 into the mortise 34 of an adjacent second panel 12 supports the adjacent first and second panels 12 in an angular relationship to one another. To secure the connection between the first and second panels 12, one or more connectors 60 are inserted through axially aligned apertures 36 and 42. The one or more connectors 60 function to releasably secure the first panel 12 to an adjacent second panel 12 as will be understood by a person of ordinary skill in the art. The process is repeated until the livestock feeder of desired size and shape is constructed.

FIG. 7 shows two connected adjacent panels 12 with connections 66 resulting from the tenons 40 being slidably received in the mortises 34, and connections 68 resulting from the contact of vertical faces 32 and 38. Connections 66 and 68 may support the adjacent panels 12 in an angular relationship to one another. The angular relationship between two adjacent panels 12 may have a varying angle depending on the shape of the livestock feeder 10 and the number of panels 12 used, such as, 30°, 45°, 60°, 90°, 108°, 120°, 135°, 180°, and combinations thereof, for example. It is to be understood that such angles are not limited to whole numbers, and may be measured relative to the inside of the hay retaining space 14, or from the outside of the hay retaining space 14, for example.

It is to be understood that while FIGS. 6 and 7 show a connector 60 comprising a bolt 62 and a nut 64, it will be appreciated that other types of connectors may be used with the instant inventive concept, such as a rod, a pin, a rivet, a screw, a shank, and combinations thereof, for example.

From the above description, it is clear that the inventive concept(s) disclosed herein is well adapted to carry out the objects and to attain the advantages mentioned herein as well as those inherent in the inventive concept disclosed herein. While presently preferred embodiments of the inventive concept disclosed herein have been described for purposes of this disclosure, it will be understood that numerous changes may be made which will readily suggest themselves to those skilled in the art and which are accomplished without departing from the scope of the inventive concept disclosed herein and defined by the appended claims.

What is claimed:

1. A livestock feeder for retaining hay so that livestock can consume the hay without trampling thereon, comprising:
a plurality of polymeric panels interconnectable with one another to define a hay retaining space so as to permit access to hay in the hay retaining space by livestock while preventing livestock from trampling hay in the hay retaining space,
each polymeric panel having a first vertical end member, a second vertical end member, a plurality of horizontal retainer members extending between the first vertical end member and the second vertical end member so as to support the first vertical end member and the second vertical end member in a spaced apart relationship, and a longitudinal axis extending through the first vertical end member and the second vertical end member, the first vertical end member having at least one mortise angularly disposed relative to the longitudinal axis and the second vertical end member having at least one tenon angularly disposed relative to the longitudinal axis and slidably receivable in the mortise of the first vertical end member of an adjacent like polymeric panel so as to support the adjacent like polymeric panels in an angular relationship to one another when the tenon of the polymeric panel is disposed in the mortise of the adjacent like polymeric panel.

2. The livestock feeder of claim 1 wherein the mortise is a horizontally oriented groove and the tenon is a horizontally oriented projection.

3. The livestock feeder of claim 2 wherein the projection has a proximal end and a distal end and wherein the projection is wider at the distal end than the proximal end, and wherein the groove has a proximal end and a distal end and wherein the groove is narrower at the distal end than the proximal end.

4. The livestock feeder of claim 3 wherein the groove has opposing open ends.

5. The livestock feeder of claim 1, wherein the mortise and the tenon are substantially aligned with at least one of the horizontal retainer members.

6. The livestock feeder of claim 1 wherein the first vertical end member has a plurality of vertically spaced mortises and wherein the second vertical end member has a plurality of corresponding vertically spaced tenons.

7. The livestock feeder of claim 2 wherein the first vertical end member has a plurality of vertically spaced mortises and wherein the second vertical end member has a plurality of corresponding vertically spaced tenons.

8. The livestock feeder of claim 1 wherein the first vertical end member has a vertical end surface disposed at an angle relative to the longitudinal axis and wherein the second vertical end member has a vertical end surface disposed at a corresponding angle to the longitudinal axis such that the vertical end surface of the first vertical end member of the polymeric panel is disposed in a face to face relationship with the vertical end surface of the adjacent like polymeric panel when the tenon of the polymeric panel is disposed in the mortise of the adjacent like polymeric panel.

9. The livestock feeder of claim 1 wherein the first vertical end member and the second vertical end member each include a plurality of vertically spaced apertures, the apertures of the first vertical end member being axially aligned with a corresponding aperture of the second vertical end member of the adjacent like polymeric panel when the tenon of the polymeric panel is disposed in the mortise of the adjacent like polymeric panel, and wherein the livestock feeder further comprises a plurality of connectors disposable through the axially aligned apertures.

10. The livestock feeder of claim 9 wherein the apertures of the first vertical end members are positioned between the mortises thereof and wherein the apertures of the second vertical end members are positioned between the tenons thereof.
